(19) United States
(12) Patent Application Publication
(10) Pub. No.: US 2019/0008718 A1
(43) Pub. Date: Jan. 10, 2019

(54) BEAUTY CARE TOOL

(71) Applicant: MTG Co., Ltd., Nagoya (JP)

(72) Inventor: Tsuyoshi MATSUSHITA, Nagoya-Shi (JP)

(21) Appl. No.: 15/715,994

(22) Filed: Sep. 26, 2017

(30) Foreign Application Priority Data
Jul. 5, 2017 (JP) 2017132141
Sep. 11, 2017 (JP) 2017174381

(51) Int. Cl. A61H 15/00; A61H 7/00

(52) U.S. Cl. CPC A61H 15/0092; A61H 7/007; A61H 7/003

(57) ABSTRACT

A beauty care tool includes: a handle; and a first rotating body and a second rotating body respectively fitted to the handle. The first rotating body and the second rotating body are molded carbon products, and a spacing between rotational axes thereof is progressively larger away from the handle.

### BACKGROUND OF THE INVENTION

### 1. Field of the Invention

The present invention relates to beauty care tools that provide beauty benefit to the skin.

### 2. Description of the Related Art

Beauty care tools designed to allow a user to apply a rotating body, i.e., a roller, to the skin and roll the roller are known. When the beauty care tool is used for the face, the face line around the chin is tightened and the user can experience the benefit of lifted skin. Using the tool more actively in the fashion of lymphatic massage promotes drainage of waste matter, improves metabolism, and makes the skin glossier. Using the tool for the foot facilitates removing swelling and cellulite, which are happy benefits particularly for women.

Utility Model Registration 3194033 and JP2013-103086 disclose beauty care tools designed to allow a user to apply a roller and roll the roller. By using these beauty care tools, the roller massages the skin and provides the benefits of promoting the bloodstream and lifting up the skin.

A lot of users of beauty care tools are women. Women who are beauty conscious always look for beauty care tools that provide better beauty benefit. In this background, we have come to consider that there is room for improvement in beauty care tools from the viewpoint of improvement in beauty benefit.

### SUMMARY OF THE INVENTION

In this background, a general purpose of the present invention is to provide a beauty care tool in which the beauty benefit is improved.

An embodiment of the present invention relates to a beauty care tool. The beauty care tool comprises: a handle; and a first rotating body and a second rotating body respectively fitted to the handle. The first rotating body and the second rotating body are molded carbon products, and a spacing between rotational axes thereof is progressively larger away from the handle.

According to this embodiment, the far-infrared radiation from the first rotating body and the second rotating body that are molded carbon products and the pulling up of the skin using the two rotating bodies promote the bloodstream and the circulation of lymphatic fluid and activate cells.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view of a beauty care tool according to the first embodiment;

FIG. 2 is a top view of the beauty care tool according to the first embodiment;

FIG. 3 is a front view showing how the beauty care tool according to the first embodiment is used;

FIG. 4 is a side view showing how the beauty care tool according to the first embodiment is used;

FIG. 5 is a partial sectional view along A-A in FIG. 2;

FIG. 6 is a sectional view along B-B in FIG. 2;

FIG. 7 is a partial top view of the base body of the handle according to the first embodiment;

FIG. 8 shows the holding member according to the first embodiment;

FIG. 9 is a perspective view of the bearing according to the first embodiment;

FIGS. 10A and 10B are schematic diagrams illustrating the benefit and advantage of the beauty care tool according to the first embodiment;

FIG. 11 shows an alternative configuration of the beauty care tool according to the first embodiment;

FIG. 12 is a sectional view of a beauty care tool according to the second embodiment;

FIG. 13 is a schematic configuration diagram of a beauty care system according to the third embodiment;

FIG. 14 is a partial sectional view of the beauty care tool according to the third embodiment;

FIG. 15 is a perspective view of a beauty care tool according to the fourth embodiment;

FIG. 16A is a top view of the beauty care tool according to the fourth embodiment, FIG. 16B is a front view, and FIG. 16C is a bottom view;

FIG. 17 is a sectional view along C-C in FIG. 16A;

FIG. 18 is a sectional view along D-D in FIG. 16A;

FIG. 19 is a sectional view along E-E in FIG. 16B;

FIG. 20 is a partial sectional view of the roller of the beauty care tool according to the fourth embodiment;

FIG. 21 is a perspective view of a beauty care unit according to the fifth embodiment;

FIG. 22 is a front view of the beauty care unit according to the fifth embodiment;

FIG. 23 is a side view of the beauty care unit according to the fifth embodiment;

FIG. 24 is a plan view of the beauty care unit according to the fifth embodiment;

FIG. 25 is a perspective view of a cradle according to the fifth embodiment;

FIG. 26 is a partial sectional view along F-F in FIG. 22;

FIG. 27 is a partial sectional view along G-G in FIG. 24;

FIGS. 28A and 28B are schematic diagrams showing a beauty care tool according to variation 1;

FIGS. 29A and 29B are schematic diagrams showing a beauty care tool according to variation 2; and

FIG. 30 shows a roller of a beauty care tool according to a variation and the neighborhood thereof.

### DETAILED DESCRIPTION OF THE INVENTION

The invention will now be described by reference to the preferred embodiments. This does not intend to limit the scope of the present invention, but to exemplify the invention.

Like numerals are used in the description to denote like elements and the description is omitted as appropriate. For brevity of the description, some of the constituting elements are omitted as needed in the drawings.

### First Embodiment

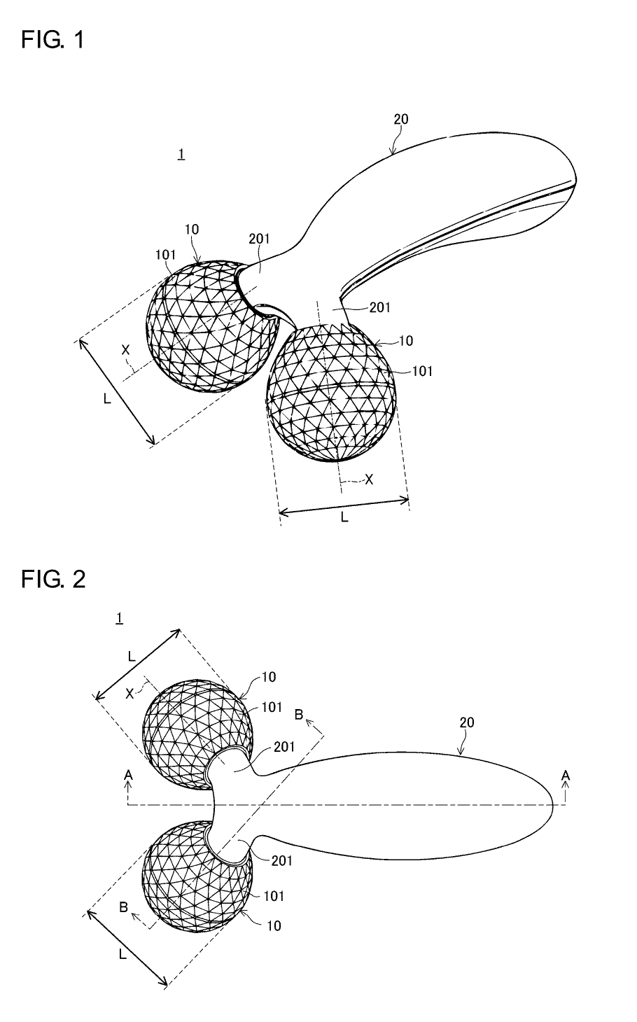

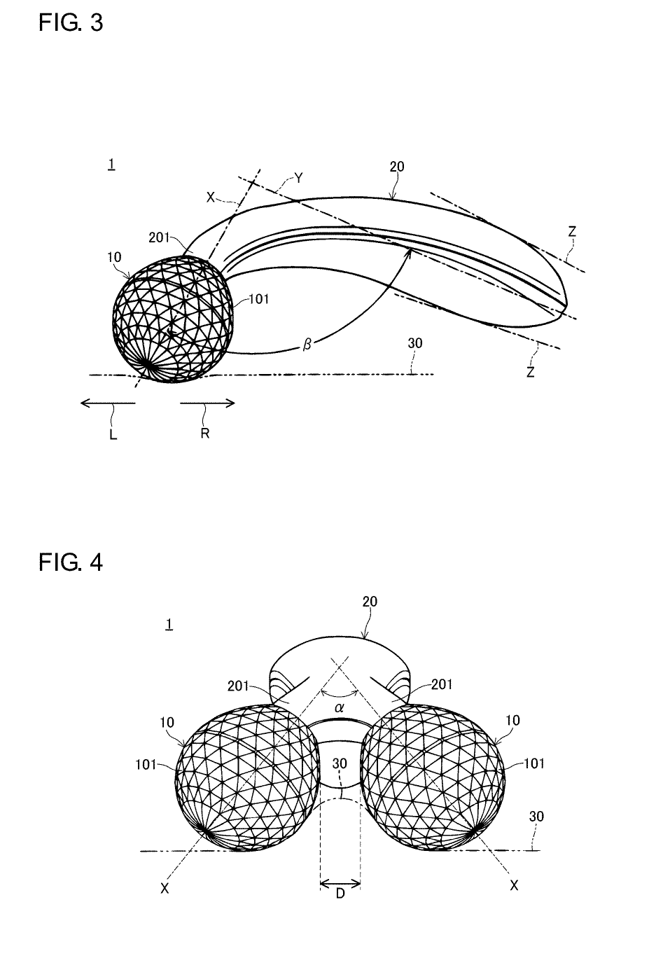

FIG. 1 is a perspective view of a beauty care tool 1 according to the first embodiment, FIG. 2 is a top view of the beauty care tool 1, FIG. 3 is a front view showing how the beauty care tool 1 is used, and FIG. 4 is a side view showing how the beauty care tool 1 is used.

The beauty care tool 1 has a pair of rollers 10 and a handle 20. Each roller 10 is a rotating body with a black surface formed into a spherical shape and is rotatably supported by a forked part 201 provided at one end of the handle 20. The user of the beauty care tool 1 holds the handle 20 and applies and rolls the roller 10 on the face, arm, etc. The skin is kneaded and spread flat between the rollers 10 so that the bloodstream and the circulation of lymphatic fluid are promoted at the portion of contact. Further, the skin is lifted up and tightened. Thus, the beauty care tool 1 provides various beauty benefits.

The roller 10 is formed into a spherical shape having a large number of triangular faces 101 on its surface. Alternatively, the roller 10 may be formed into an elliptical shape, columnar shape, etc. instead of a spherical shape. Also, the faces 101 may be polygonal, circular, etc. instead of triangular. Still alternatively, the faces 101 may not be provided and the whole surface may be configured as a smooth surface.

The roller 10 is a molded carbon product made of a material containing carbon. The source material is produced by adding a binder to carbon powders of graphite. The roller 10 is made by pressurizing the source material, molding the pressurized material into a spherical shape, and calcinating the molded product at a high temperature and over a long time. By calcination, carbon powders are bound together and are turned into a crystal, i.e., graphitized and crystallized.

Due to the property of carbon, the roller 10 has a high coefficient of thermal conductivity and high emissivity. For this reason, the roller 10 is heated to substantially the same temperature as a skin 30 in a short period of time since the beauty care tool 1 begins to be used, increasing the amount of far-infrared radiation. When the roller 10 radiates far-infrared rays to the skin 30, the bloodstream and the circulation of lymphatic fluid of the skin 30 are promoted.

The roller 10 is rotatably supported by the handle 20 around a rotational axis X. The maximum diameter L of the roller 10 in a direction perpendicular to the rotational axis X is defined to be 40 mm. Our experiments demonstrate that, for use of the beauty care tool 1 on the face or arm, the maximum diameter L of the roller 10 is preferably 15˜60 mm, and, more preferably, 32˜55 mm, and, still more preferably, 38˜45 mm. If the maximum diameter L of the roller 10 is smaller than 15 mm, the area of contact between the roller 10 and the skin 30 will be small, resulting in insufficient benefit and advantage provided by the beauty care tool 1. Meanwhile, if maximum diameter L of the roller 10 is larger than 60 mm, it may be difficult to apply and rotate the roller 10 depending on the portion of the body.

A spacing D between the pair of rollers 10 is defined to be 11.5 mm. For proper pulling up and spreading of the skin 30, the spacing D between the rollers 10 is preferably 8˜25 mm, and, more preferably, 9˜15 mm, and, still more preferably, 10˜13 mm. If the spacing D is smaller than 8 mm, the force for pulling up the skin 30 may be too strong or it may be difficult to spread the skin 30 flat. Meanwhile, if the spacing D is larger than 25 mm, it may be difficult to pull up the skin 30.

Each of the pair of rollers 10 is fitted to a supporting shaft described later provided at one end of the handle 20. The two supporting shafts are provided such that the spacing between the rotational axes X of the rollers 10 is progressively larger away from the handle 20. This allows the skin 30 to be pulled up as if it is caught up between the two rollers 10 as the user applies the roller 10 to the skin 30 and moves the rollers 10 in a direction indicated by an arrow R as shown in FIG. 3. Conversely, as the user moves the rollers 10 in a direction indicated by an arrow L, the skin 30 is spread flat by the two rollers 10. By providing an angle of spread α between the rotational axes X of the two rollers 10, the user can use the rollers 10 for dual purposes of pulling up the and spreading the skin 30.

The angle of spread α is defined to be 75°. For the purpose of facilitating the action of pulling up or spreading of the skin 30 by the rollers 10, the angle of spread α is preferably 50˜110°, and, more preferably, 50˜90°, and, still more preferably, 65˜85°. If the angle of spread is smaller than 50°, the force for pulling up the skin 30 may be too strong or it may be difficult to spread the skin 30 flat. Meanwhile, if the angle of spread α is larger than 110°, it may be difficult to pull up the skin 30.

The roller 10 is provided such that the rotational axis X is at an angle to a central line X of the handle 20. The central line Y of the handle 20 is a line parallel to a line bisecting the angle between external tangential lines Z of the thickest part of the handle 20 in a front view of the beauty care tool 1. An angle of inclination β between the rotational axis X of the roller 10 and the central line Y of the handle 20 is defined to be 95°. The angle of inclination β is defined to be an angle at which the user holding the handle 20 finds it easy to apply the roller 10 to the skin 30 and rotate the roller 10.

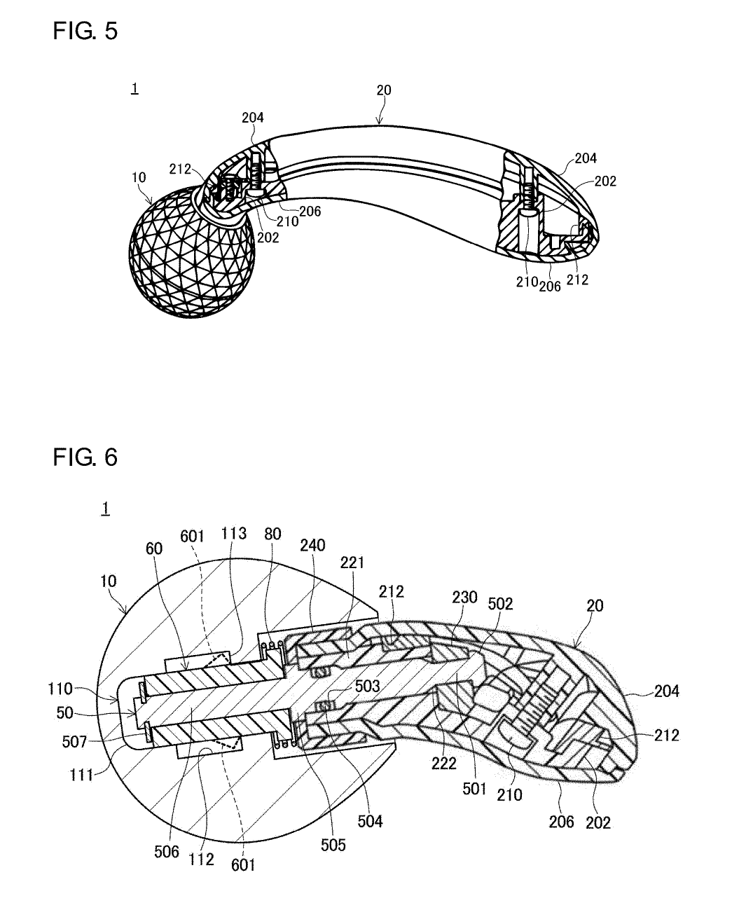

FIG. 5 is a partial sectional view along A-A in FIG. 2. The handle 20 has a base body 202, an upper cover body 204, and a lower cover body 206. These components are made of a resin material. The surfaces of the upper cover body 204 and the lower cover body 206 are formed with a metal plating layer.

The base body 202 is housed between the upper cover body 204 and the lower cover body 206. The upper cover body 204 is fixed to the base body 202 by a screw 210. The lower cover body 206 is set in outer circumferential edge of the upper cover body 204.

A ring-shaped packing 212 is provided at the outer circumference of the base body 202 so as to be integrated with the base body 202 by two-color molding. The outer circumferential edge of the packing 212 is in pressure contact with the inner circumferential surface of the upper cover body 204 while the base body 202 is covered by the upper cover body 204 and the lower cover body 206 so as to seal a space between the base body 202 and the upper cover body 204.

FIG. 6 is a sectional view along B-B in FIG. 2. The handle 20 is provided with a supporting shaft 50 that rotatably supports the roller 10. The supporting shaft 50 is made of a metallic material. The base end of the supporting shaft 50 is held by the handle 20. The distal end projecting from the handle 20 rotatably supports the roller 10.

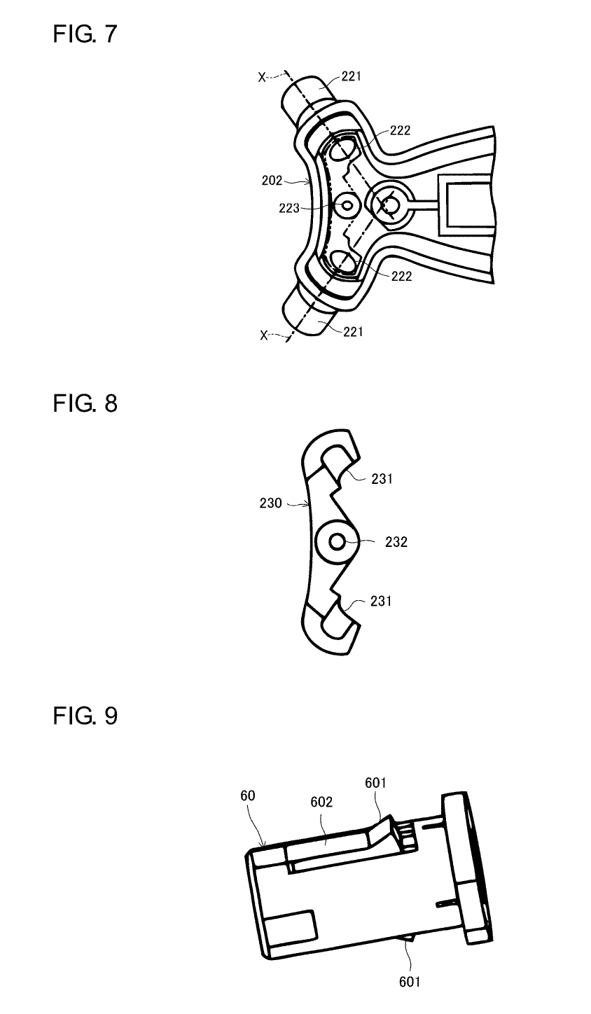

FIG. 7 is a partial top view of the base body 202 of the handle 20 according to the first embodiment and shows a part of the handle 20 corresponding to the forked part 201 of the handle 20. The base body 202 is formed with a pair of support cylinders 221. The support cylinder 221 is formed with a through shaft hole 222 that extends along the rotational axis X of the roller 10. The base end of the supporting shaft 50 is inserted into the shaft hole 222. A holding member 230 for holding the supporting shaft 50 is fitted to the base body 202 at a position indicated by the two-dot chain line in FIG. 6 while the supporting shaft 50 is inserted into the shaft hole 222.

FIG. 8 shows the holding member 230 according to the first embodiment viewed from the side of the base body 202 while the holding member 230 is fitted to the base body 202. The holding member 230 is made of a resin material and has a holding part 231 and a screw hole 232. The holding member 230 is fixed to the base body 202 by a screw inserted into a fixing hole 223 of the base body 202 via the screw hole 232. The holding part 231 is formed into a semicylindrical shape and supports the base end side of the supporting shaft 50 when the holding member 230 is fixed to the base body 202.

As shown in FIG. 6, the base end side of the supporting shaft 50 supported by the handle 20 is formed with a held part 501 with a diameter smaller than elsewhere Also, a stopper 502 with a diameter larger than that of the held part 501 is formed in the supporting shaft 50. The base end side of the supporting shaft 50 is inserted into the shaft hole 222 of the base body 202 and the held part 501 is held by the holding part 231 of the holding member 230. In this state, the stopper 502 is latched by the holding member 230, preventing the supporting shaft 50 from being dislodged from the handle 20.

The end of the handle 20 toward the roller 10 is covered by a cap 240. The cap 240 is made of a resin material and formed into a cylindrical shape and seals a space between the base body 202 and the upper cover body 204 and a space between the base body 202 and the lower cover body 206. Further, the opening at one end is set in a flange part 505 of the supporting shaft 50 and reduces looseness of the supporting shaft 50.

A seal ring 504 is fitted to a recess 503 in the supporting shaft 50 positioned inward of the shaft hole 222 of the base body 202. The seal ring 504 seals a space between the outer circumferential surface of the supporting shaft 50 and the inner circumferential surface of the shaft hole 222. The end of the handle 20 toward the roller 10 is dually sealed by the cap 240 and the seal ring 504.

A bearing 60 is fitted to a supporting part 506 of the supporting shaft 50 projecting from the handle 20. A stopper ring 507 is provided at the distal end of the supporting part 506. The stopper ring 507 is set in a groove formed at the distal end of the supporting shaft 50 to prevent the bearing 60 from being dislodged from the supporting shaft 50. The inner circumferential surface of the bearing 60 as fitted to the supporting shaft 50 rotatably comes into contact with the outer circumferential surface of the supporting shaft 50.

FIG. 9 is a perspective view of the bearing 60 according to the first embodiment. The bearing 60 is made of a resin material and formed into a cylindrical shape. The bearing 60 has a latching pawl 601 and a support piece 602. The latching pawl 601 is formed so as to project from one end of the support piece 602 outward from the bearing 60. The end of the support piece 602 opposite to the latching pawl 601 is joined to the side wall of the bearing 60. The support piece 602 is deflected by being elastically deformed when the latching pawl 601 is pushed inward with respect to the bearing 60.

As shown in FIG. 6, the supporting shaft 50 as fitted with the bearing 60 is inserted into a bearing hole 110 formed in the roller 10. The bearing hole 110 is formed with an R (round) part 111 at the circumferential edge of the bottom end of the bearing hole 110 opposite to the opening. By forming the R part 111 to round the surface of the bottom end, concentration of the stress at the circumferential edge of the bottom end of the bearing hole 110 is prevented and occurrence of cracks is inhibited. A recess 112 in which the latching pawl 601 of the bearing 60 is set is formed on the inner circumferential surface of the bearing hole 110. When the latching pawl 601 is introduced into the recess 112, the latching pawl 601 is latched by a step 113 formed in the recess 112 toward the handle 20. This prevents the supporting shaft 50 and the bearing 60 from being dislodged from the roller 10.

When the supporting shaft 50 and the bearing 60 are inserted into the bearing hole 110, the roller 10 is rotatably supported by the handle 20. When the roller 10 is applied to the skin and rolled, the roller 10 is rotated along with the bearing 60.

Further, a coil spring 80 as a shock absorber is provided between the roller 10 and the cap 240. The coil spring 80 presses the roller 10 in a direction away from the handle 20. When the roller 10 hits against something or falls onto the floor, the coil spring 80 is compressed, absorbing the shock exerted to the roller 10 and mitigates damage received by the roller 10. The coil spring 80 may be provided between the bearing 60 and the cap 240 of the handle 20. The shock absorber may not be the coil spring 80 so long as it is an elastic member elastically deformed and capable of absorbing shock. For example, the shock absorber may be made of rubber, foamed styrol, or a urethane sheet.

Described above is the first embodiment. The roller 10 of the beauty care tool 1 is a molded carbon product and promotes the bloodstream and lymphatic fluid circulation of the skin with the far-infrared radiation effect. Pulling up the skin by the two rollers 10 adds to the far-infrared radiation effect by further promoting the bloodstream and the lifting up of the skin.

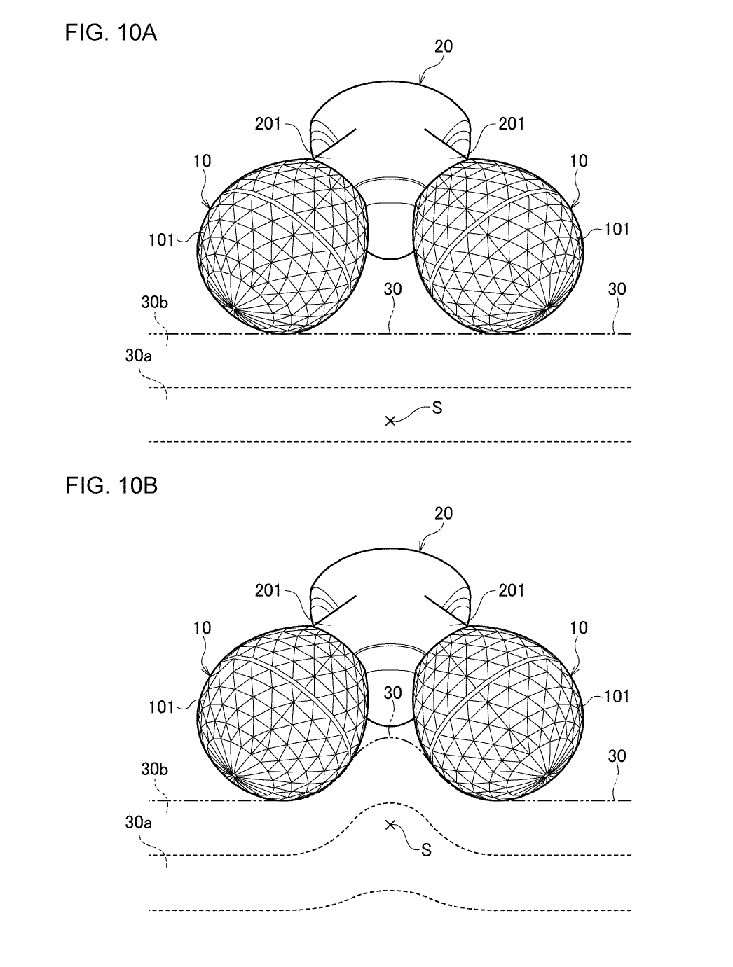

FIGS. 10A and 10B are schematic diagrams illustrating the benefit and advantage of the beauty care tool 1. FIG. 10a shows a state occurring before the skin 30 is pulled up, and FIG. 10B shows that the skin 30 is pulled up as if is caught up between the two rollers 10. According to the beauty care tool 1, the skin 30 is pulled up as if it is caught up between the two rollers 10 and the skin 30 thus pulled up comes into contact with the roller 10, as shown in FIG. 10B. In essence, by pulling up the skin 30, the area of contact between the skin 30 and the two rollers 10 is increased. This transmits the heat from the skin 30 to the two rollers 10 faster and in a larger amount. The two rollers 10 are heated to a temperature substantially equal to the temperature of the skin 30 in a shorter period of time, or the two rollers 10 are heated to a temperature closer to that of the skin 30, i.e., to a higher temperature, increasing the amount of far-infrared radiation. The wavelength of water molecules in the body is substantially identical to the wavelength of far-infrared rays emitted from carbon. When far-infrared waves reach water molecules in the body, water molecules are oscillated by resonance and collide with other water molecules. The collision of water molecules produces heat, which promotes the bloodstream and the circulation of lymphatic fluid. As the amount of far-infrared radiation from the two rollers 10 is increased, the oscillation of water molecules in the body grows. As a result, a larger amount of heat is generated due to the collision of water molecules the bloodstream and the circulation of lymphatic fluid are further promoted.

In further accordance with the beauty care tool 1, the distance between the two rollers 10 and the deep skin is reduced as a result of the skin 30 being pulled up as if it is caught up between the two rollers 10. For example, as shown in FIGS. 10A and 10B, the distance between the two rollers 10 and a dermic layer 30a (e.g., the deep skin S) is reduced as a result of the skin 30 being pulled up. Far-infrared rays may not reach the dermic layer 30a if the skin 30 is not pulled up, but, by pulling up the skin 30, it is ensured that far-infrared rays reach the dermic layer 30a more properly, allowing water molecules in the deep portion of the skin 30 to resonate. Further, the oscillation of water molecules will be more powerful in portions reached by far-infrared rays radiated from both of the two rollers 10. In other words, the beauty care tool 1 is capable of generating larger oscillation of water molecules in the deeper portion of the skin 30 and, consequently, further promoting the bloodstream and the circulation of lymphatic fluid.

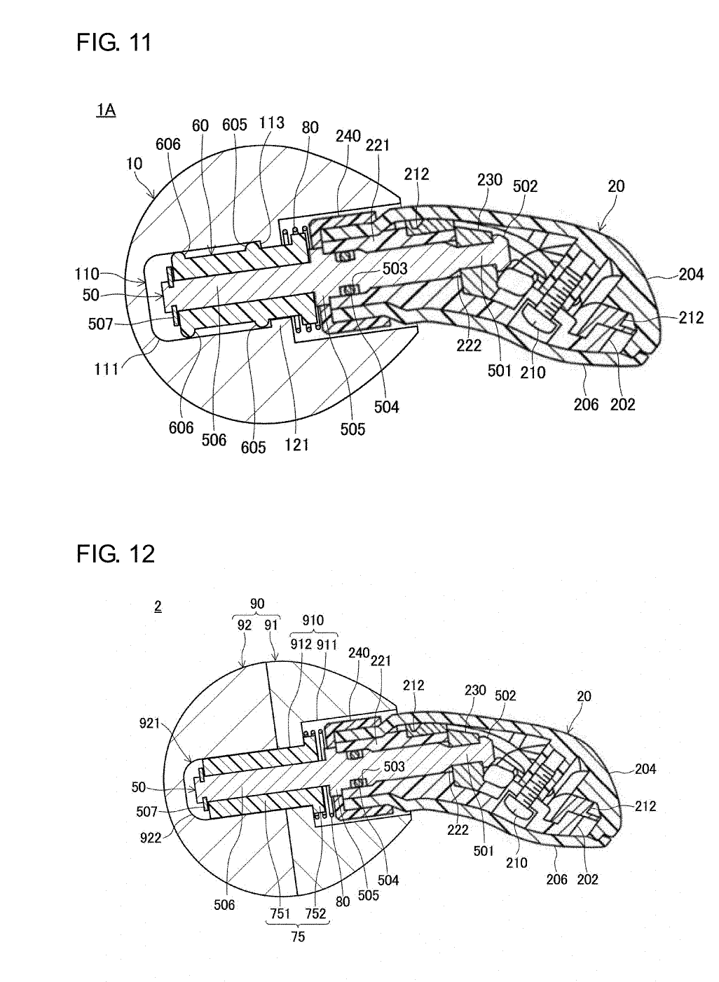

FIG. 11 shows an alternative configuration. In a beauty care tool 1A shown in FIG. 11, the bearing 60 is formed with a first projection 605 and a second projection 606. These projections project outward from the outer circumferential surface of the bearing 60 at different positions in the direction of the rotational axis. Further, the bearing hole 110 is formed with a projecting part 121 that projects inward. When the bearing 60 is inserted into the bearing hole 110, the first projection 605 is latched by the step 113 formed by the projecting part 121. The first projection 605 and the second projection 606 are in contact with the inner circumferential surface of the bearing hole 110 at different positions in the direction of the rotational axis and reduce looseness of the roller 10 in the direction of the rotational axis.

### Second Embodiment

FIG. 12 is a sectional view of a beauty care tool 2 according to the second embodiment. A roller 90 has a base part 91 and a cover part 92. The base part 91 and the cover part 92 are molded carbon products formed by the same material and method as those of the rollers 10 according to the first embodiment and are formed into a semispherical shape so that the base part 91 and the cover part 92 are joined to form a spherical body.

The base part 91 is formed with a bearing hole 910 in which a bearing 75 is fixed. The bearing hole 910 has a large-diameter part 911 and a small-diameter part 912 and extends through the base part 91. The bearing 75 fixed in the bearing hole 910 has a cylindrical part 751 and a flange part 752. The bearing 75 is fixed in the bearing hole 910 by an adhesive while the cylindrical part 751 is inserted into the small-diameter part 912 and the flange part 752 is latched by a step between the large-diameter part 911 and the small-diameter part 912.

The supporting shaft 50 is inserted into the bearing 75 fixed in the small-diameter part 912 of the bearing hole 910. The supporting shaft 50 extends through the bearing 75. The stopper ring 507 is provided at the distal end of the supporting shaft 50. The stopper ring 507 is set in a groove formed at the distal end of the supporting shaft 50 to prevent the bearing 75 from being dislodged from the supporting shaft 50.

The cover part 92 is formed with a recess 921 having the same diameter as the small-diameter part 912 of the bearing hole 910. The recess 921 houses the distal ends of the supporting shaft 50 and the bearing 75. The recess 921 is formed with an R (round) part 922 at the circumferential edge of the bottom end of the recess 921 opposite to the opening. The R part 922 prevents concentration of the stress and reduces the occurrence of cracks.

The cover part 92 is fixed to the base part 91 while the bearing 75 is set in the recess 921. The base part 91 and the cover part 92 are bonded by an adhesive. The portions of bonding are polished so that the portions mate seamlessly with each other after the adhesive is dried.

The beauty care tool 2 is provided with the coil spring 80 as a shock absorber between the stepped surface separating the large-diameter part 911 and the small-diameter part 912 of the bearing hole 910 the base part 91, and the cap 240 of the handle 20. The coil spring 80 presses the roller 90 in a direction away from the handle 20. The coil spring 80 is compressed when a shock is exerted to the roller 90 and mitigates damage received by the roller 90. The coil spring 80 may be provided between the flange part 752 of the bearing 75 and the cap 240 of the handle 20.

Described above is the second embodiment. The beauty care tool 2 according to the second embodiment provides the same advantage as the beauty care tool 1 according to the first embodiment. In the beauty care tool 2, the supporting shaft 50 is rotatably fitted to the bearing 75 fixed to the bearing hole 910 of the roller 90. The bearing hole 910 of the roller 90 and the bearing 75 can be configured in a more simplified fashion.

So long as it is possible to insert the supporting shaft 50 into the bearing 75 fixed to the base part 91 and to provide the stopper ring 507, the base part 91 and the cover part 92 may have shapes different from those of the embodiment. Further, the roller 90 may comprise three or more parts.

### Third Embodiment

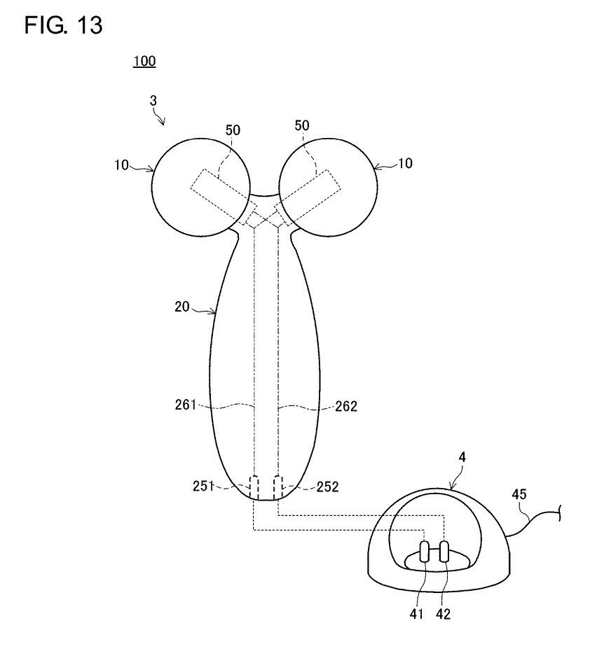

FIG. 13 is a schematic configuration diagram of a beauty care system 100 according to the third embodiment. The beauty care system 100 has a beauty care tool 3 and an adaptor 4. The beauty care tool 3 has a heat generator inside the rollers 10. The rollers 10 are heated by the heat generator so that the amount of far-infrared radiation is increased. This provides additional beauty benefit.

The handle 20 of the beauty care tool 3 is provided with a first power receiving terminal 251 and a second power receiving terminal 252 as power receiving units for receiving electric power from the adaptor 4. Further, the beauty care tool 3 is provided with a first lead 261 and a second lead 262 respectively leading from the first power receiving terminal 251 and the second power receiving terminal 252 to the respective supporting shafts 50 that support the respective rollers 10.

The adaptor 4 has a first power supplying terminal 41, a second power supplying terminal 42, and a power supplying cable 45. The first power supplying terminal 41 and the second power supplying terminal 42 are connected to the power supplying cable 45. When the beauty care tool 3 is placed on the adaptor 4, the first power supplying terminal 41 and the first power receiving terminal 251 are connected, and the second power supplying terminal 42 and the second power receiving terminal 252 are connected.

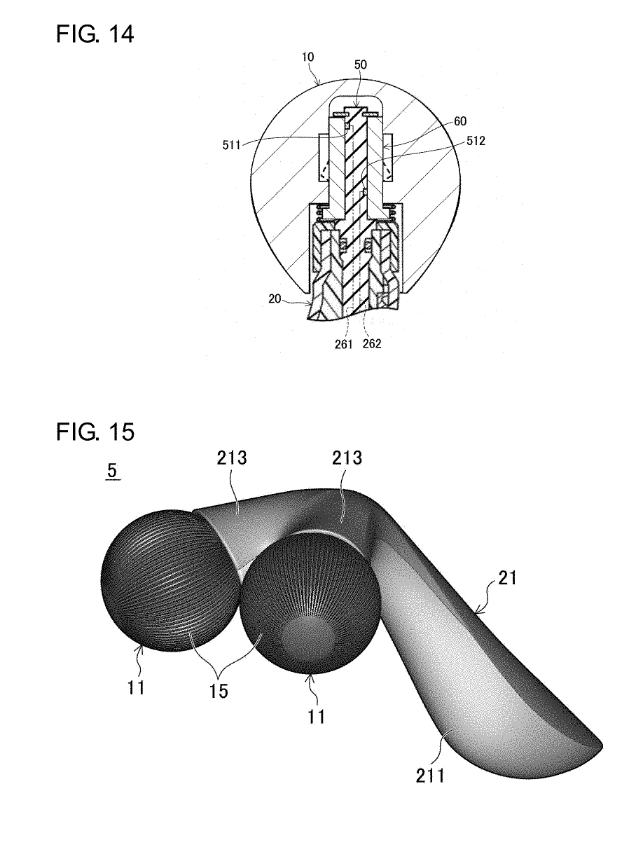

FIG. 14 is a partial sectional view of the beauty care tool 3. The bearing 60 of the beauty care tool 3 is a heat generator made of nichrome. The bearing 60 may be made of a Kanthal wire, a cupronickel alloy, etc. A portion of the bearing 60 may be a heat generator.

The supporting shaft 50 is provided with a first electrode 511 and a second electrode 512. The first electrode 511 and the second electrode 512 are exposed on the outer circumferential surface of the supporting shaft 50 at different positions in the direction of the rotational axis and are in contact with the bearing 60. The portions of the supporting shaft 50 other than the first electrode 511 and the second electrode 512 are made of a resin material. The first lead 261 is connected to the first electrode 511. Further, the second lead 262 is connected to the second electrode 512.

When the beauty care tool 3 is placed on the adaptor 4, electric power is fed to the beauty care tool 3 via the first power receiving terminal 251 and the second power receiving terminal 252. The bearing 60 of the beauty care tool 3 is energized and heated to a high temperature and heats the rollers 10 from inside. As the rollers 10 are heated by the bearing 60, the amount of far-infrared radiation is increased. This enhances the far-infrared radiation effect so that the beauty care tool 3 can provide increased beauty benefit.

Described above is the third embodiment. The beauty care tool 3 of the beauty care system 100 according to the third embodiment provides the same advantage as the beauty care tool 1 according to the first embodiment. In further accordance with the beauty care tool 3 of the beauty care system 100, the rollers 10 are heated by the internal heat generator so that higher far-infrared radiation effect is provided.

The handle 20 of the beauty care tool 3 may be provided with a battery for energizing the bearing 60 and a switch for switching the condition of conducting power from the battery to the bearing 60. In this case, the user can heat the rollers 10 by using the switch. In the beauty care tool 2 according to the second embodiment, the bearing 75 may be a heat generator. In this case, the first power receiving terminal 251, the second power receiving terminal 252, the first lead 261, and the second lead 262 are provided in the handle 20, and the first electrode 511 and the second electrode 512 are provided in the supporting shaft 50, as in the case of the beauty care tool 3 according to the third embodiment.

### Fourth Embodiment

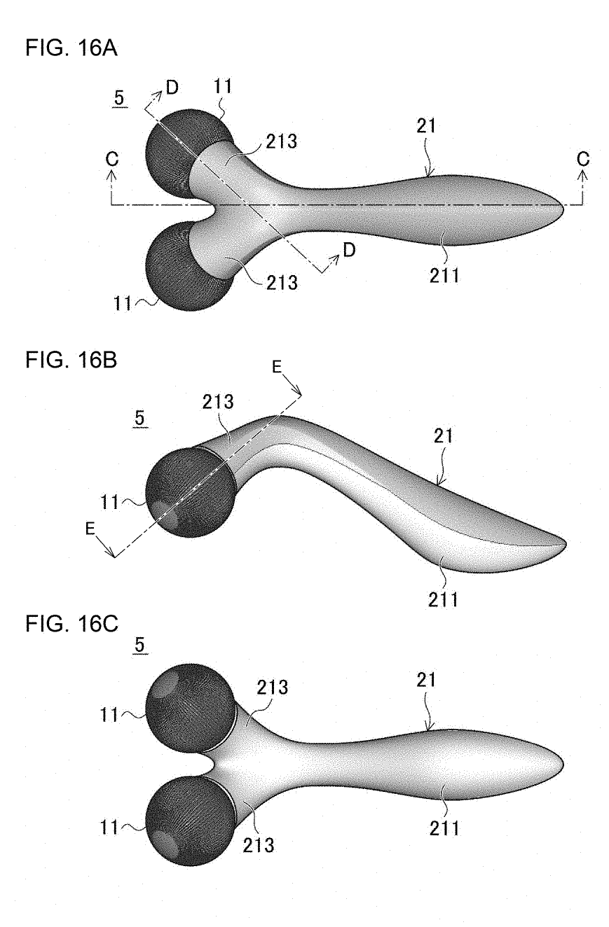

FIG. 15 is a perspective view of a beauty care tool 5 according to the fourth embodiment. FIG. 16A is a top view of the beauty care tool 5, FIG. 16B is a front view, and FIG. 16C is a bottom view.

The beauty care tool 5 has a pair of rollers 11 and a handle 12. Each of the rollers 11 is a molded carbon product formed by the same material and method as those of the rollers 10 according to the first embodiment and is rotatably supported by the handle 21. The surface of the roller 11 is formed with a plurality of grooves 15 extending along the rotational axis. Stated in another way, the roller 11 is formed with a plurality of grooves 15 radially extending from one end of the roller 11 in the direction of the rotational axis to the other end. The handle 21 has a main body 211 held by the user and a forked part 213 that branches from one end of the main body 211. The forked part 213 is provided with a supporting shaft for rotatably supporting the roller 11. The diameter, spacing, angle of spread, angle of inclination of the rotational axis relative to the central line Y of the handle 21 are the same as those of the first embodiment.

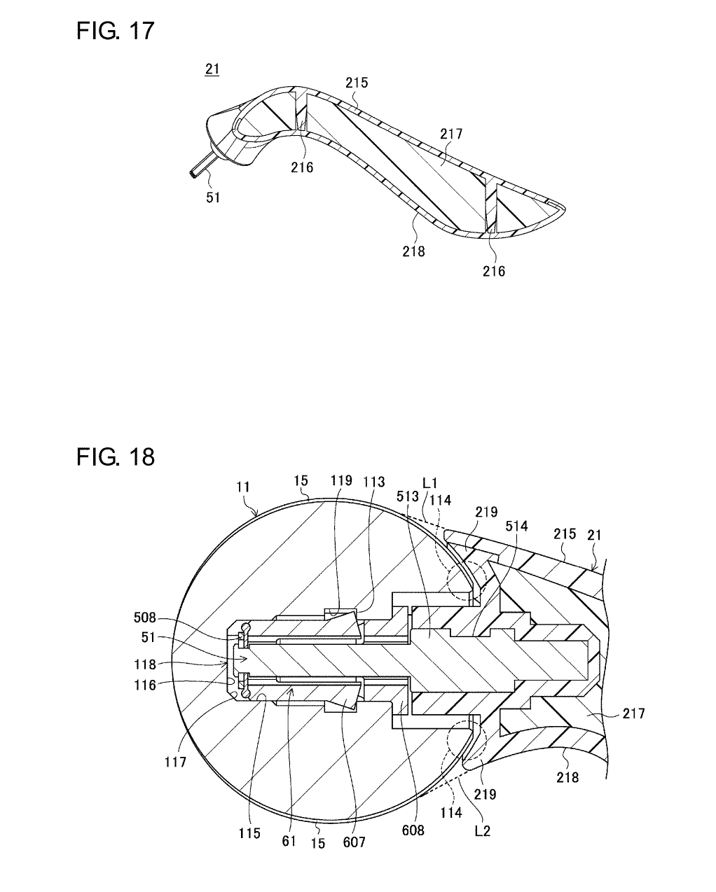

FIG. 17 is a sectional view along C-C in FIG. 16A. The handle 21 has an upper cover body 215, a handle core 217, and a lower cover body 218. A method of manufacturing the handle 21 will be described. First, the upper cover body 215 is molded from a resin. The upper cover body 215 is provided with a cruciform boss 216 for positioning the handle core 217. Subsequently, the handle core 217 and the upper cover body 215 are molded together by two-color molding. Further, the lower cover body 218 is molded together with the upper cover body 215, the handle core 217, and a supporting shaft 51 mounted to the mold. In case the handle 21 is relatively thick, sink marks are prevented from being created in the upper cover body 215 and the lower cover body 218, which are exposed outside, by configuring the handle core 217 to be thick to conform to the thickness of the handle 21 and configuring the upper cover body 215 and the lower cover body 218 to be thin. By fixing the supporting shaft 51 to the handle 21 by insert molding, assembly errors of the supporting shaft 51 are reduced. This minimizes variation between individual products of the beauty care tool 5 and secures the functions such as the pulling up and spreading by the two rollers 11.

FIG. 18 is a sectional view along D-D in FIG. 16A. The supporting shaft 51 is fixed to the lower cover body 218 of the handle 21. The supporting shaft 51 has a large-diameter part 513 having a larger diameter than the other parts. The large-diameter part 513 is formed with a D cut face 514. By causing the large-diameter part 513 including the D cut face 514 to be latched to the lower cover body 218, the supporting shaft 51 is fixed to the handle 21. The lower cover body 218 has a skirt part 219 that covers an opening circumferential edge 114 of a bearing hole 118 formed in the roller 11. Since the opening circumferential edge 114 is covered by the skirt part 219 and is not exposed outside, it is unlikely that the opening circumferential edge 114 is cracked or broken. Further, infiltration of foreign materials into the roller 11 is inhibited. The skirt part 219 may be formed in the upper cover body 215 or the handle core 217.

The bearing hole 118 of the roller 11 is a hole that sinks in a columnar shape and accepts the supporting shaft 51. A tapered surface 117 angled such that the diameter in a cross section perpendicular to the axial direction of the supporting shaft 51 is progressively smaller from a side surface 115 toward a bottom surface 116 is formed at the bottom end of the bearing hole 118 opposite to the opening. This prevents concentration of the stress at the bottom end and inhibits occurrence of cracks in the bearing hole 118. As in the case of the first embodiment, the bottom end of the bearing hole 118 may be rounded. The inner circumferential surface of the bearing hole 118 is formed with a recess 119 in which a latching pawl 607 of a bearing 61 described later is set. When received by the recess 119, the latching pawl 607 is latched by the step 113 defined by the recess 119.

The supporting shaft 51 is fitted with the bearing 61. The bearing 61 is a slip bearing having the latching pawl 607 projecting outward. The distal end of the supporting shaft 51 is fitted with a stopper ring 508 when the bearing 61 is inserted. When the bearing 61 is inserted into the bearing hole 118 along with the supporting shaft 51, the latching pawl 607 is set in the recess 119 of the bearing hole 118, causing a flange part 608 of the bearing 61 to be set in the opening of the bearing hole 118. When the roller 11 is applied to the skin and is rotated, the bearing 61 is rotated along with the roller 11 relative to the supporting shaft 51.

The forked part 213 of the handle 20 is shaped to spread toward the roller 11 in the shape of a trumpet. When viewed in a cross section such as FIG. 18, the forked part 213 is formed such that extensions L1, L2 thereof are smoothly contiguous with the outer circumference of the roller 11. This produces a slick appearance that gives an impression the forked part 213, and, ultimately, the handle 21 and the roller 11 are an integrated member.

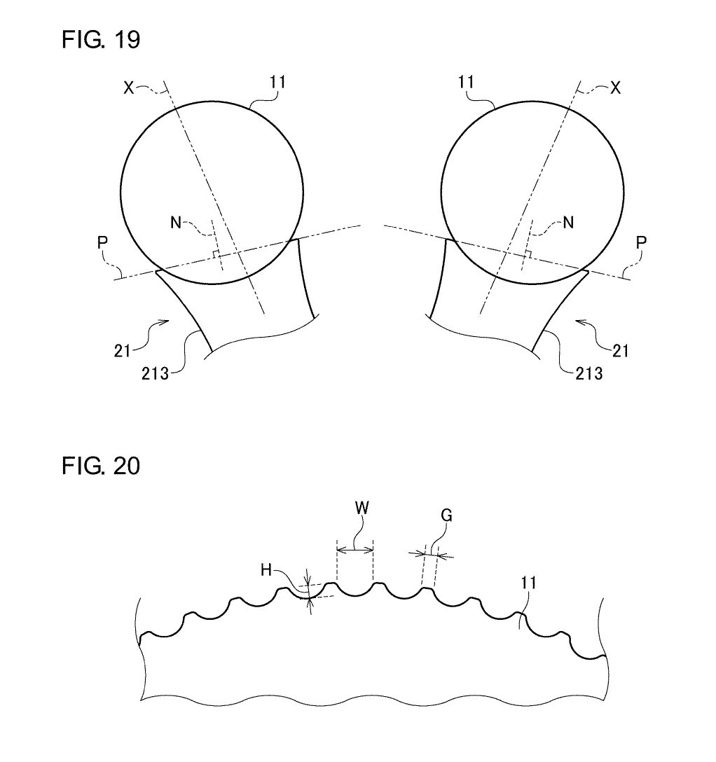

FIG. 19 is a sectional view along E-E in FIG. 16B. FIG. 19 is a sectional view defined by a plane that includes the rotational axis of the roller 11. Referring to FIG. 19, a plane P represents a plane parallel to the end face of the forked part 213 of the handle 21 toward the roller 11. As is evident from FIG. 19, the roller 11 and the forked part 213 are formed such that the rotational axis X of the roller 11 is not parallel to a normal N to the plane P and that the closer to the other roller 11 along the rotational axis X, the larger the portion of the roller 11 not covered by the forked part 213, i.e., exposed. This prevents the forked part 213 from being in the way of the skin that is pulled up so that the user can use the tool comfortably.

FIG. 20 is a partial sectional view of the roller 11. FIG. 20 is a partial sectional view defined by a plane that includes the equatorial line of the roller 11. The equatorial line of the roller 11 is defined as a great circle formed by a plane perpendicular to the rotational axis of the roller 11 intersecting the outer circumferential surface of the roller 11. Given that the maximum diameter L of each roller 11 in a direction perpendicular to the rotational axis X, the spacing D between the two rollers 11, and the angle of spread α of the rotational axes of the two rollers 11 are of the dimensions in the range described in the first embodiment, the dimensions of the grooves 15 are preferably as indicated below for the purpose of properly pulling up or spreading the skin 30, or increasing the area of contact with the skin and enhancing the far-infrared radiation effect.

groove width W: 1.1˜1.4 mm
groove spacing G: 0.5˜0.7 mm
groove depth H: 0.4˜0.5 mm
number of grooves: 50˜60

Further, the relationship between the groove width W and the groove depth H is preferably such that the ratio of the groove depth H to the groove width W is 0.36. If the ratio of the groove depth H to the groove width W is larger than 2.0, i.e., if the groove 15 is too deep, the skin will not be in contact with the bottom surface of the groove 15. The presence of the groove 15 would result in the opposite effect of reducing the contact area.

Described above is the fourth embodiment. The beauty care tool 5 according to the fourth embodiment provides the same advantage as the beauty care tool 1 according to the first embodiment. In further accordance with the beauty care tool 5, the grip power of the roller 11 is increased due to the grooves 15 formed on the surface of the roller 11 so that the skin can be easily pulled up or spread flat with a lighter force. Moreover, the skirt part 219 of the handle 21 covers the opening circumferential edge 114 of the bearing hole 118 of the roller 11 so that cracking and breaking of the roller 11 and infiltration of foreign materials inside are inhibited. This ensures that the roller 11 can be used for a long period of time and can continue to be rotated in a stable manner. The beauty benefit from far-infrared radiation, pulling up, and spreading can be exhibited over a long term. A shock absorber may be provided between the bearing 61 and the handle 21. The shock absorber will reduce damage received by the roller 11 when the tool is dropped and so allows the tool to be used over a longer term. A description is given above of the configuration in which the surface of the roller 11 is formed with recesses in the form of grooves 15 that extends radially. The embodiment is not limited to as to the configuration of recesses. For example, the recesses may be formed as grooves in a grid pattern. Still alternatively, a plurality of dimples such as those of golf balls may be formed on the surface of the roller 11 as recesses. In this case, the benefit of pulling up or spreading the skin are improved as in the case of the grooves 15.

The grooves 15 formed in the roller 11 of the beauty care tool 5 increases the surface area of the roller 11 as compared with the case where the grooves 15 are not formed in the roller 11. Therefore, the area of contact between the skin 30 and the roller 11 is increased. This transmits the heat from the skin 30 to the two rollers 10 faster and in a larger amount. The two rollers 10 are heated to a temperature substantially equal to the temperature of the skin 30 in a shorter period of time, or the two rollers 10 are heated to a temperature closer to that of the skin 30, i.e., to a higher temperature. As a result, the bloodstream and the circulation of lymphatic fluid are further promoted.

In further accordance with the beauty care tool 5, the user can know at a glance that the roller 11 is being rotated since the grooves 15 are formed in the rollers 11. It is therefore easy to check the rotational performance visually as part of a quality test conducted before shipping the product.

So long as it is possible to realize the handle 21 of a proper appearance that is free of sink marks, the handle 21 may be configured differently from the embodiment. For example, the handle 21 may comprise two members, and, in particular, two members that are thin enough not to create sink marks. In this case, the manufacturing cost of the handle 21 is reduced. Further, the handle 21 may be formed by flow molding, for example. In this case, only one mold is required to mold the handle 21 so that the manufacturing cost of the handle 21 is reduced.

The dimensions of the parts of suitable examples of the beauty care tool 5 according to the fourth embodiment are shown below.

### First Example

angle of spread α: 70°
spacing D between rollers D: 11.2 mm
maximum diameter L of roller: 40 mm
groove width: 1.4 mm
groove to groove distance: 0.7 mm
groove depth: 0.4˜0.5 mm
number of grooves: 60

### Second Example

angle of spread α: 70°
spacing D between rollers D: 7.6 mm
maximum diameter L of roller: 33 mm
groove width: 1.1 mm
groove to groove distance: 0.5˜0.6 mm
groove depth: 0.4˜0.5 mm
number of grooves: 60

### Third Example

angle of spread α: 70°
spacing D between rollers D: 7.45 mm
maximum diameter L of roller: 27 mm
groove width: 1.1˜1.2 mm
groove to groove distance: 0.5 mm
groove depth: 0.4˜0.5 mm
number of grooves: 50

We conducted a test to check the benefit of the beauty care tool 5 according to the fourth embodiment. More specifically, tests were conducted to check differences in user experience, using the beauty care tool 5 according to the first example of the fourth embodiment and a beauty care tool according to a comparative example configured similarly as the beauty care tool 5 according to the first example except that the grooves 15 are not formed in the rollers 11.

Tests were conducted on men and women aged 20˜40 (5 men, 5 women). The subjects were allowed to remain at rest for 20˜30 minutes prior to the test and to use the beauty care tool 5 on the right cheek and the beauty care tool according to the comparative example on the left cheek for 10 minutes. The subjects were guided to move the beauty care tool back and forth 60 times per minute in synchronization with a metronome. The subjects were allowed to apply the rollers 11 to the skin with a strength that he or she can feel comfortable.

After the test, each subject was requested to evaluate the warmth (feeling of being bathed in warmth) after use on a scale of one to ten. The beauty care tool 5 yielded an average score of 4.7 and the beauty care tool according to the comparative example yielded an average score of 3.7. The test demonstrates that the presence of the grooves 15 makes the skin warmer.

### Fifth Embodiment

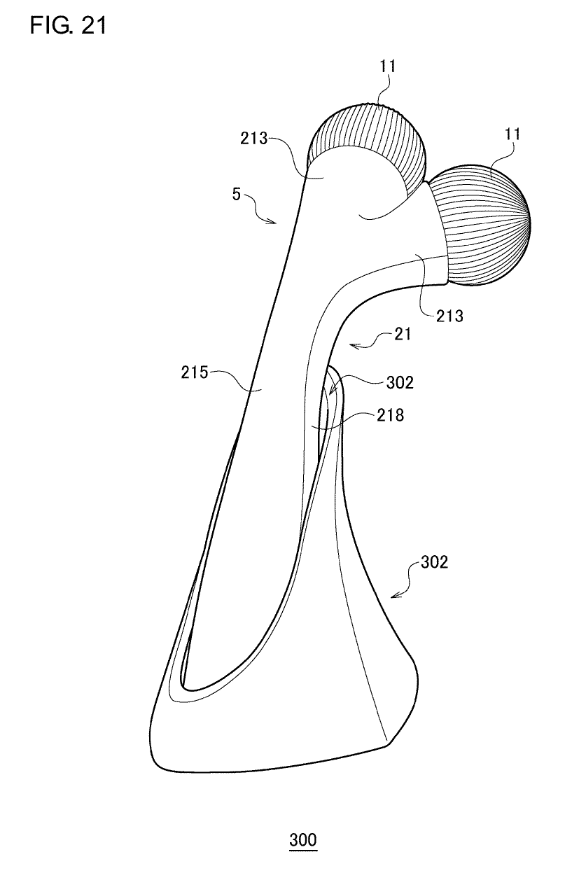

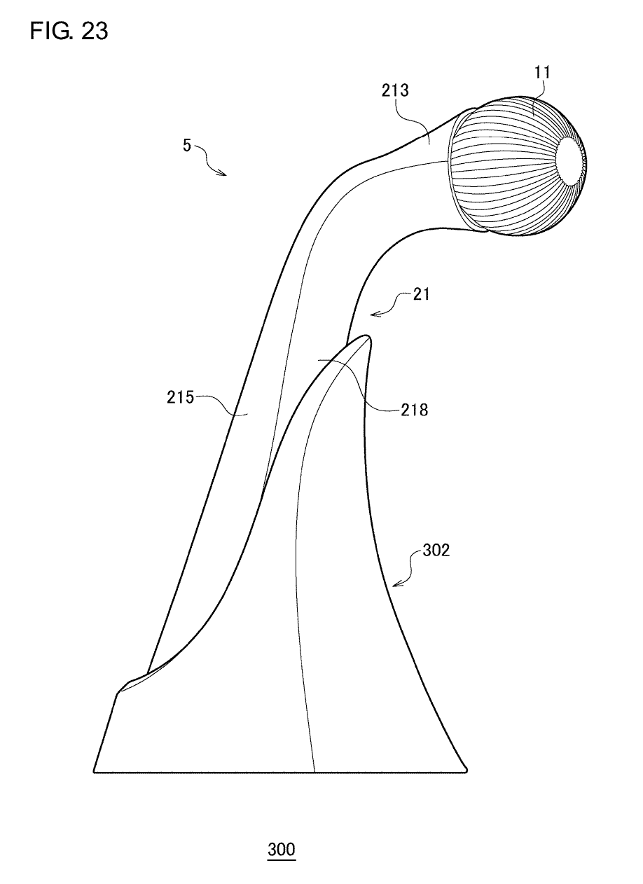

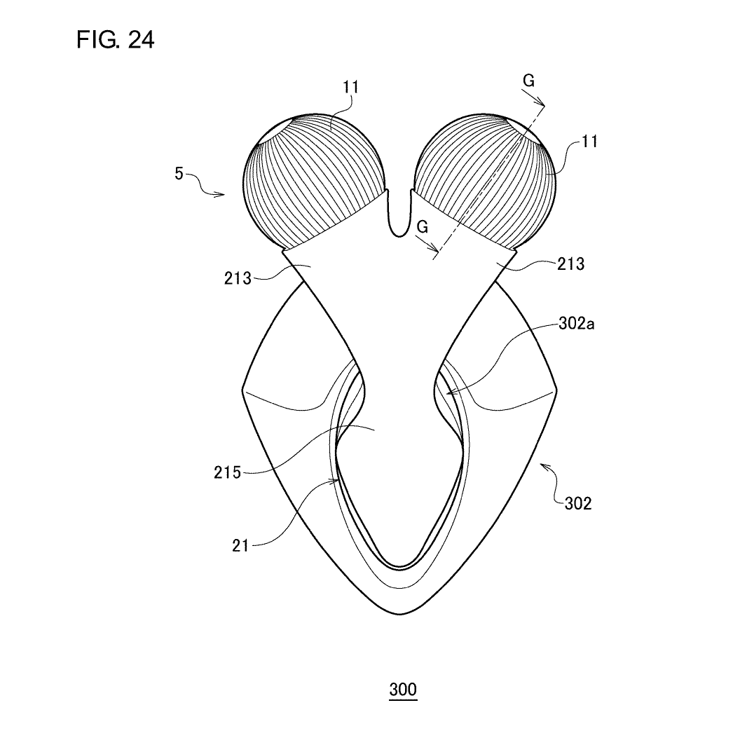

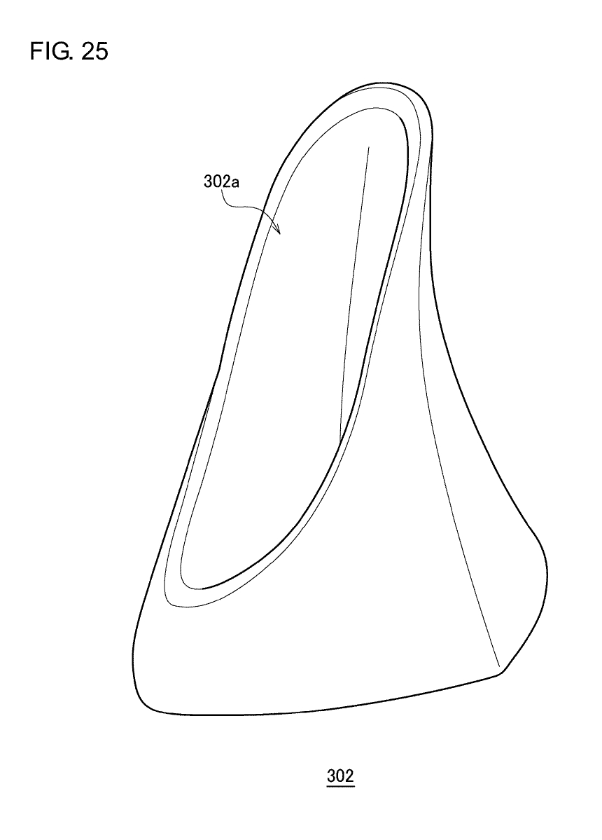

FIGS. 21 to 24 are a perspective view, a front view, a side view, and a plan view of a beauty care unit 300 according to the fifth embodiment. FIG. 25 is a perspective view of a cradle 302. The beauty care unit 300 has the beauty care tool 5 and the cradle 302.

The cradle 302 has a substantially conical shape. A recess 302a is formed on the outer circumferential surface of the cradle 302.

The beauty care tool 5 is placed on the cradle 302 such that a portion of the handle 21 is housed the recess 302a. Specifically, the beauty care tool 5 is placed on the cradle 302 such that the rollers 11 are located at the uppermost position in the beauty care tool 5 and the end of the handle 21 opposite to the rollers 11 is located at the lowermost position in the beauty care tool 5. In this state, the upper cover body 215 of the handle 21 forms a portion of the substantially conical shape, producing a slick appearance that gives an impression that the handle 21, and, ultimately, the beauty care tool 5 and the cradle 302 are an integrated member. The rollers 11 look as if they are afloat. Specifically, the rollers 11 are not in contact with the cradle 302 or other stands, or the floor surface etc. (i.e., not grounded) and at least a portion (e.g., 50% or 90%) thereof is not positioned straight above the cradle 302. Since the rollers 11 are not in contact with the cradle 302, etc., the rollers 11 can be maintained in a more hygienic condition than otherwise.

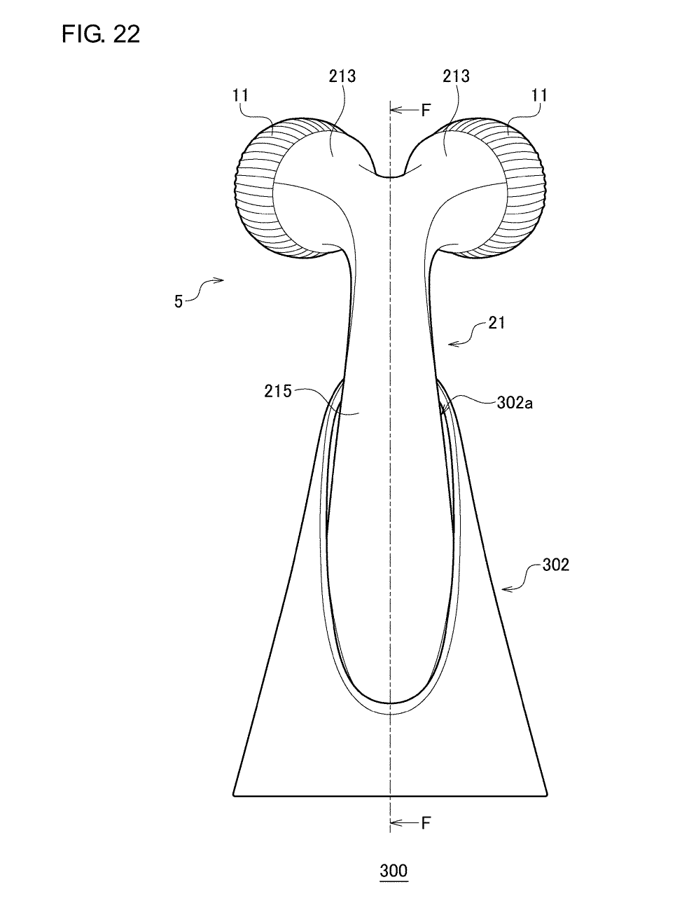

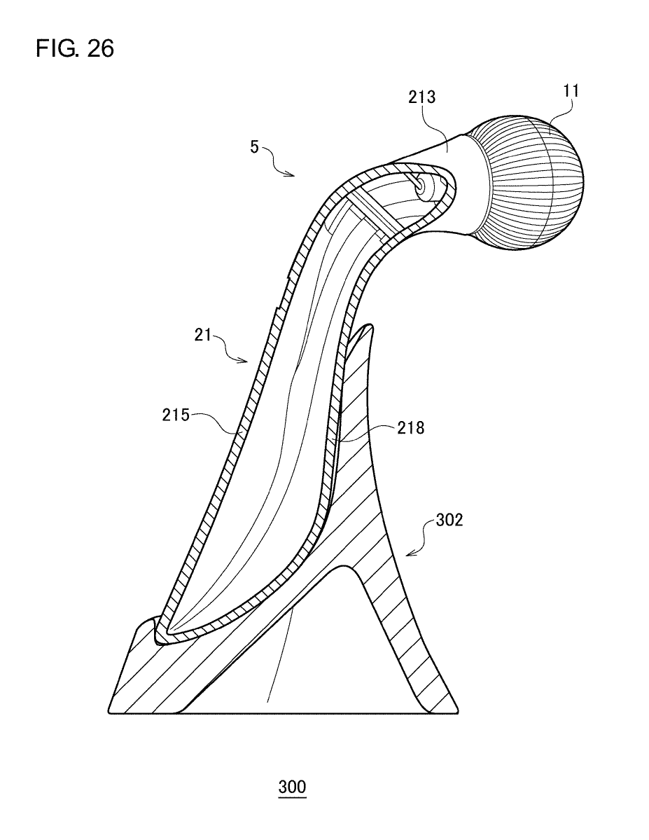

FIG. 26 is a partial sectional view along F-F in FIG. 22. When the beauty care tool 5 is placed on the cradle 302, the lower cover body 218 leans against the circumferential wall of the recess 302a. Further, the end of the upper cover body 215 opposite to the rollers 11 is locked by the cradle 302. This prevents the beauty care tool 5 from falling over under the weight of the rollers 11 and maintains the beauty care tool 5 placed on the cradle 302.

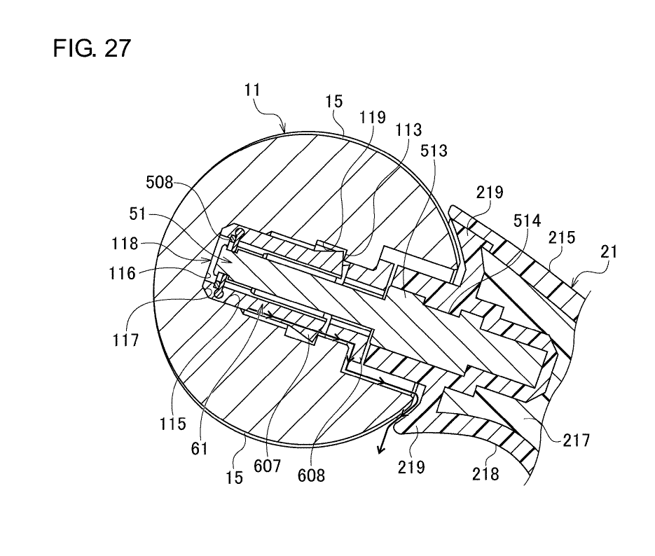

FIG. 27 is a partial sectional view along G-G in FIG. 24. FIG. 27 corresponds to FIG. 18. The difference is that FIG. 27 is a partial sectional view of the beauty care tool 5 placed on the cradle 302. The opening of the bearing hole 118 is located below the end opposite to the opening. This ensures that, so long as the beauty care tool 5 remains placed on the cradle 302, water infiltrating the bearing hole 118 of the beauty care tool 5 used in, for example, a bathroom is drained from the bearing hole 118. The skirt part 219 prevents the water drained from the bearing hole 118 from entering the handle 21 and guides the water to be drained outside the beauty care tool 5.

Described above is the fifth embodiment. According to the beauty care unit 300, the rollers 11 of the beauty care tool 5 are not grounded so that the rollers 11 are maintained in a hygienic condition.

Described above is an explanation based on an exemplary embodiment. The embodiment is intended to be illustrative only and it will be obvious to those skilled in the art that various modifications to constituting elements and processes could be developed and that such modifications are also within the scope of the present invention. It has been described above that one or two rollers are provided. Alternatively, the number of rollers provided in the beauty care tool may be 3 or more. The configuration in the embodiments can also be applied to beauty care tools in which the rollers comprise, for example, a resin or a metal instead of being molded carbon products. Further, the rollers may be made of other highly emissive materials capable of providing the benefit of far-infrared radiation such as ceramic, glass, etc.

### (Variation 1)

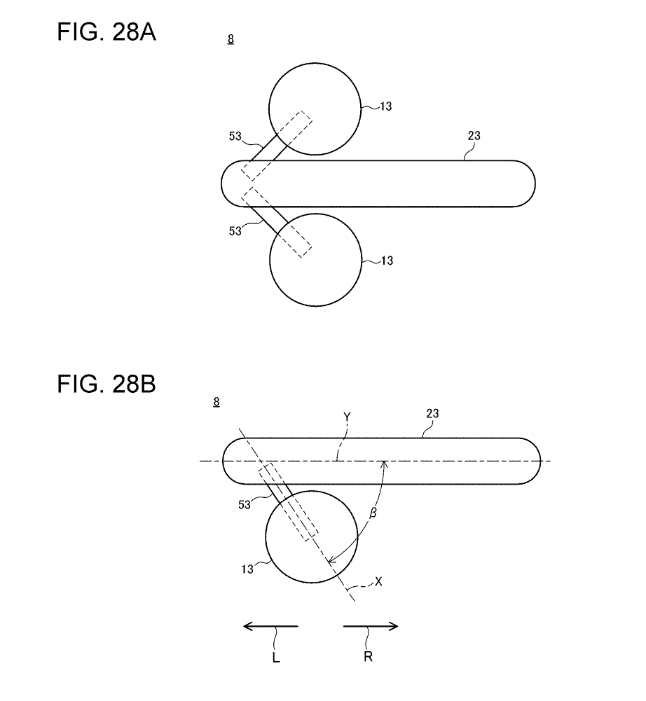

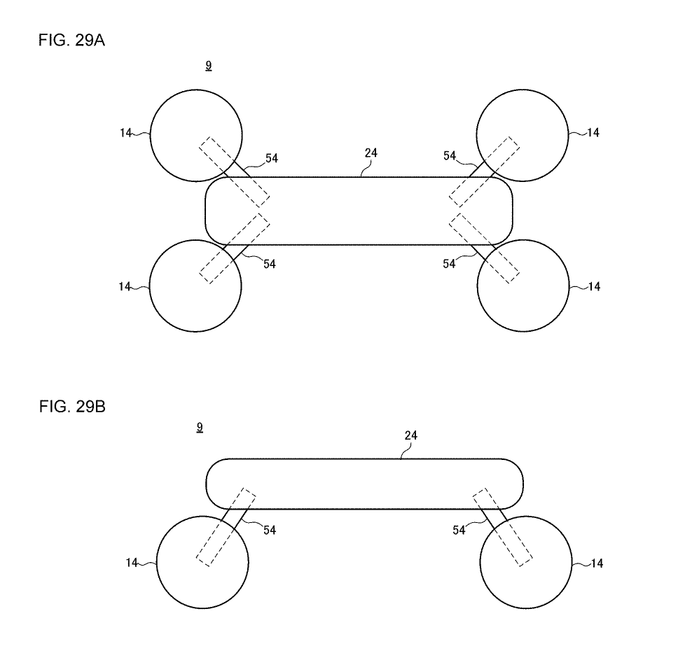

FIGS. 28A and 28B are schematic diagrams showing a beauty care tool 8 according to variation 1. FIG. 28A is a top view of the beauty care tool 8 and FIG. 28B is a front view thereof. The beauty care tool 8 has a pair of rollers 13 and a handle 23. Each of the rollers 13 is fitted to a supporting shaft 53 projecting from one end of the handle 23. The two supporting shafts 53 are provided such that the spacing between the rotational axes of the rollers 13 is progressively larger away from the handle 23. Each of the rollers 13 is a spherical molded carbon product formed by the same material and method as the rollers 10 according to the first embodiment. The supporting shaft 53 is provided below the handle 23 and toward the other end of the handle 23. The angle β of inclination between the rotational axis X of the roller 13 and the central line Y of the handle 23 is defined to be 90° or less. The configuration allows the two rollers 13 to pull up the skin by holding the handle 23 such that the central line Y is approximately parallel to the surface of the skin and moving the handle 23 in a direction indicated by an arrow L shown in FIG. 28B. Further, by moving the handle 23 in a direction indicated by an arrow R, the skin can be spread flat between the two rollers 13. Thus, by defining the angle of inclination to be less than 90°, the beauty care tool can be used in the same manner as the tool of the foregoing embodiments and equally provides significant beauty benefit.

### (Variation 2)

FIGS. 29A and 29B are schematic diagrams showing a beauty care tool 9 according to variation 2. FIG. 29A is a top view of the beauty care tool 9 and FIG. 29B is a front view thereof. The beauty care tool 9 has four rollers 14 and a handle 24. Each of the rollers 14 is a spherical molded carbon product formed by the same material and method as the rollers 10 according to the first embodiment. The roller 14 is fitted to each of two supporting shafts 54 projecting from one end of the handle 24. The roller 14 is also fitted to each of the two supporting shafts 54 projecting from the other end of the handle 24. Each supporting shaft 54 is inserted into a dint provided in the roller 14 and rotatably supports the roller 14. The two supporting shafts 54 at one end of the handle 24 are provided such that the spacing between the rotational axes of the two rollers 14 is progressively larger away from the handle 24. The two supporting shafts 54 at the other end are also provided such that the spacing between the rotational axes of the two rollers 14 is progressively larger away from the handle 24. The beauty care tool 9 is capable of massaging two portions at the same time, by pulling up or spreading the skin flat with the two rollers 14 at one end of the handle 24 and the two rollers 14 at the other end. The angle β of inclination of at least one of the rollers 14 at one end and the rollers 14 at the other end is 90° or less. In this case, the beauty care tool can be used in the same manner as the tool of the foregoing embodiments and equally provide significant beauty benefit.

### (Variation 3)

In the first to fifth embodiments and the variations, the bearing hole formed in the rollers is described as not being a through hole. The embodiments and variations are non-limiting as to the feature, and the bearing hole may be a through hole. In this case, the manufacturing cost of the rollers can be reduced. In the first to fifth embodiments and the variations, it is described that the bearing is inserted into the bearing hole of the roller so that the roller is rotatably supported via the bearing. The embodiments and variations are non-limiting as to the feature. For example, a supporting shaft hole that is a through hole or not a through hole may be formed in the roller instead of the bearing hole. The supporting shaft may be inserted into the supporting shaft hole and directly fixed to the supporting shaft hole, and the handle may rotatably supports the supporting shaft. In this case, the bearing is omitted, i.e., the configuration is simplified so that the manufacturing cost of the beauty care tool is reduced.

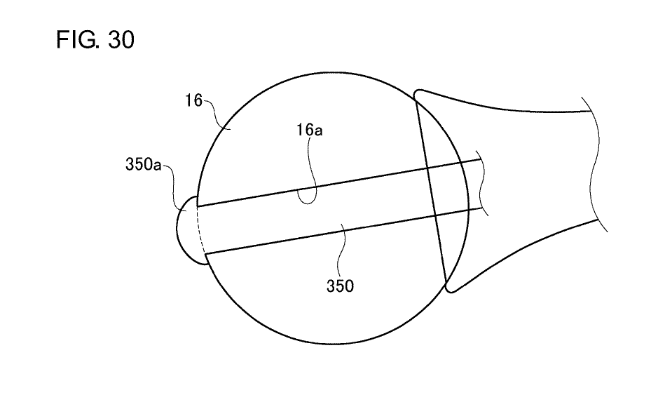

FIG. 30 shows a roller 16 of a beauty care tool according to a variation and the neighborhood thereof. In the example of FIG. 30, a supporting shaft hole 16a is formed as a through hole in the roller 16. A supporting shaft 350 is inserted into the supporting shaft hole 16a and is directly fixed to the supporting shaft hole 16a. A distal end 350a of the supporting shaft 350 is deformed so that it cannot enter the supporting shaft hole 16a in order to prevent the roller 16 from being dislodged. In the case that the supporting shaft 350 is made of resin, for example, the distal end 350a may be deformed by heat. If the supporting shaft 350 is made of, for example, a metal, the distal end 350a may be deformed by giving pressure. Instead of deforming the distal end 350a of the supporting shaft 350, a separate member not capable of entering the supporting shaft hole 16a may be fitted to the distal end of the supporting shaft 350.

### (Variation 4)

The technical idea of the third embodiment and the technical ides of the fifth embodiment may be combined. More specifically, the cradle 302 of the fifth embodiment may have the first power supplying terminal 41, the second power supplying terminal 42, and the power supplying cable 45, like the adaptor 4 of the third embodiment. The handle 21 of the beauty care tool 5 of the fifth embodiment may be provided with the first power receiving terminal 251 and the second power receiving terminal 252, like the beauty care tool 3 of the third embodiment. The beauty care tool 5 may also be provided with the first lead 261 and the second lead 262 that lead from the first power receiving terminal 251 and the second power receiving terminal 252, respectively, to the supporting shaft 350. Further, a heat generator electrically connected to the supporting shaft 350 may be provided inside each of the rollers 11. For example, the bearing 61 may be a heat generator. As the beauty care tool 5 is placed on the cradle 302, the first power supplying terminal 41 and the first power supplying terminal 251 are connected, and the second power supplying terminal 42 and the second power receiving terminal 252 are connected. Power is fed to the heat generator via these terminals, the leads, and the supporting shaft 350, causing the heat generate to generate heats. Each of the rollers 11 is heated by the heat from the heat generator so that the amount of far-infrared radiation is increased.

What is claimed is:

1. A beauty care tool comprising:
a handle; and
a first rotating body and a second rotating body respectively fitted to the handle, wherein
the first rotating body and the second rotating body are molded carbon products, and a spacing between rotational axes thereof is progressively larger away from the handle.

2. The beauty care tool according to claim 1, wherein
the first rotating body and the second rotating body are formed into a spherical shape.

3. The beauty care tool according to claim 1, wherein
a plurality of concave parts are formed on a surface of the first rotating body and the second rotating body.

4. The beauty care tool according to claim 3, wherein
the plurality of concave parts are grooves that extend from one end in a direction of rotational axis toward the other end.
